(19) United States
(12) Patent Application Publication
(10) Pub. No.: US 2005/0222835 A1
(43) Pub. Date: Oct. 6, 2005

(54) Method for automatic modeling a process control system and corresponding process control system

(76) Inventors: Fridolin Faist, Oberwolfach (DE); Andreas Isenmann, Haslach (DE)

Correspondence Address: Fay Kaplun & Marcin, LLP, Suite 702, 150 Broadway, New York, NY, 10038, US

(21) Appl. No.: 10/816,666

(22) Filed: Apr. 2, 2004

(51) Int. Cl. G06F 9/45

(52) U.S. Cl. 703/22

(57) ABSTRACT

The present invention relates to a method for automatic modeling a process control system in which elements of a user interface are arranged in a tree structure reflecting the topography of the elements in the process control system. Each element is assigned to at least one input window having a plurality of attributes for setting and/or monitoring a target apparatus controllable in the process control system. The current arrangement of the tree structure is stored as a project, and a list of all windows opened during the same current operation as well as their attributes are stored as an operating session, to thereby be able to restore the state of the elements when loading the process control system again. Moreover, the invention relates to a process control system adapted to carry out the above-referenced method.

### TECHNICAL FIELD OF THE INVENTION

The present invention relates to a method for modeling a process control system and to a corresponding process control system.

### BACKGROUND OF THE INVENTION

When process control systems are concerned, and a model of a real process control system is to be reproduced by means of graphical elements, it has to be considered that the number of graphical elements required increases with complexity of the real existing system. Usually, the graphical user interface offers the possibility, to freely position these graphical elements of the model on a working surface of the user interface. Moreover, the user interface usually is adapted to connect these graphical elements communicatingly to the real existing system.

The establishment of the model of a real existing system by means of graphical elements can basically be described as follows:

The elements of a user interface are arranged in a tree structure. This tree structure reflects the logical arrangement or function of the elements, respectively, in the real system.

Such a system could e.g. comprise a host-PC having a serial interface, a communication device and at least one sensor connected thereto via a bus. Each element of this system can make one or several graphical elements (windows) available for visualizing e.g. measurement values or for handling the system. Thus, different windows are provided for visualizing measured values and diagnoses messages. Moreover, windows exist, according to which parameters of the respective elements can be varied. Usually, these windows are adapted to be freely positioned on the working surface of the user interface.

According to for example Microsoft Visual Studio it is able to store the listing of all files involved in a working project. Also the arrangement of the graphical windows, by means of which the files of the working project can be processed, can be stored. Therefore, upon reloading of such a project, the user interface can be restored and then is in the same state, as it was during shut down.

However, it would be desirable to also store and restore the condition of the elements involved, for example with respect to communication. For the user, it would be desirable to improve the complex structure of a model of a real system, the positioning of the involved graphical elements and the communication, emanating from these elements.

### SUMMARY OF THE INVENTION

Implementations of the invention can include one or more of the following features. According to an aspect of the present invention, a method for automatic modeling a process control system is provided, whereby elements of a user interface are arranged in a tree structure reflecting the topography of the elements in the process control system, whereby each element is assigned to at least one input window having a plurality of attributes for setting and/or monitoring a target apparatus controllable in the process control system, whereby the current arrangement of the tree structure is stored as a project, and a list of all windows opened during the same current operation as well as their attributes are stored as an operating session, to thereby be able to restore the state of the elements when loading the process control system again.

Moreover, handling software is provided which is used to store the tree structure as well as the list of windows and their attributes, whereby the handling software further stores the position of the input windows during the current operation.

According to another aspect of the invention, the handling software stores the communication status, indicating an online or offline status, respectively, for storing the state of the elements. For storing the state of the elements, the handling software stores the state of the associated user interface of the respective input windows.

According to a further aspect of the present invention, only distinct communication links to distinct nodes of the complete project are selected to be restored.

Yet another aspect is that the input windows for setting and monitoring the target apparatus provided by the elements in the project tree serve for display of measured values, for diagnosis or for parametrizing.

According to still another aspect of the present invention, the current state of the input windows opened during operation of the process control system is transmitted to the handling software in a XML string. The state of the input windows opened during operation of the process control system is queried and stored by conventional interface methods.

Still another aspect is that the projects and the associated states of the elements of the project are stored in project files. Session information is stored in the project files or references to the files including session information are stored. Upon opening the project, it is verified whether session information is present, and if present, the last present view of the project with all opened dialogs is restored and all connections of the last session are restored.

According to still another aspect of the present invention, a session manager manages a list of sessions and the names of the active sessions for each project and stores the latter in a non-volatile project directory. The session manager offers a dialog during loading of a project, in which the names of all available sessions for a project are offered for selection.

According to another aspect of the present invention, a method for automatic modeling a process control system comprising at least one target apparatus is provided, whereby elements of a user interface are arranged in a tree structure reflecting the topography of the elements in the process control system, whereby each element is assigned to at least one input window having a plurality of attributes for setting and/or monitoring the target apparatus controllable in the process control system, whereby a handling software stores the current arrangement of the tree structure as a project, a list of all windows opened during the same current operation as well as their attributes as an operating session, and the position and/or the communication status, indicating an online or offline status, respectively, of the user interface of a respective input window, to thereby be able to restore the state of the elements when loading the process control system again.

One more aspect of the present invention is a process control system comprising a host PC and at least one target apparatus connected to the host PC via a bus system, whereby the process control system is adapted to be displayed in form of a tree structure on an input window, whereby the tree structure comprises nodes, each node providing at least one input window having a plurality of attributes for setting and/or monitoring a target apparatus assigned thereto, whereby a memory of the process control system is adapted to store the arrangement of the tree structure as a project, and a list of all windows opened during operation as well as their attributes as an operating session being automatically restorable during reloading of the process control system.

The memory of the process control system is adapted to store the position of the input windows. The memory is further adapted to store the communication status, indicating an online or offline status, respectively, of the input window. Moreover, the memory is adapted to store the state of the user interface associated to respective input windows. Further, the memory is adapted to store several operating sessions for each project.

According to another aspect of the present invention, the process control system is adapted to be implementable permanently in a frame application. The system can also be adapted to be implementable into the frame application as add-in.

Yet another aspect of the present invention is that the input windows are windows for visualizing measurement values obtained by the at least one target apparatus. The input windows can also be windows for diagnosis messages.

According to still one more aspect, the process control system comprises a session manager.

### BRIEF DESCRIPTION OF THE DRAWINGS

For further explanation and better understanding, several exemplary embodiments of the present invention will be described below in more detail with reference to the attached drawings, of which:

FIG. 1 is a schematic diagram of a process control system;

FIG. 2 is a screenshot of a window assigned to PACTware;

FIG. 3 is another screenshot of a PACTware window;

FIG. 4 shows a window for storing a session;

FIG. 5 shows a window for loading a session;

FIG. 6 shows a complete screenshot for loading a session.

### DESCRIPTION OF EXEMPLARY EMBODIMENTS OF THE INVENTION

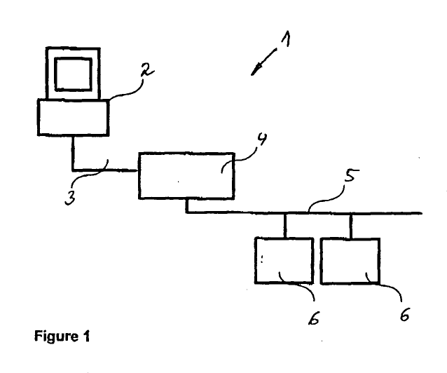

FIG. 1 shows a schematic diagram of a process control system 1, comprising a PC 2, connected to a control unit 4 via an interface 3. The control unit is conncected via a bus system 5 to two target apparatuses 6 which in this case are sensors.

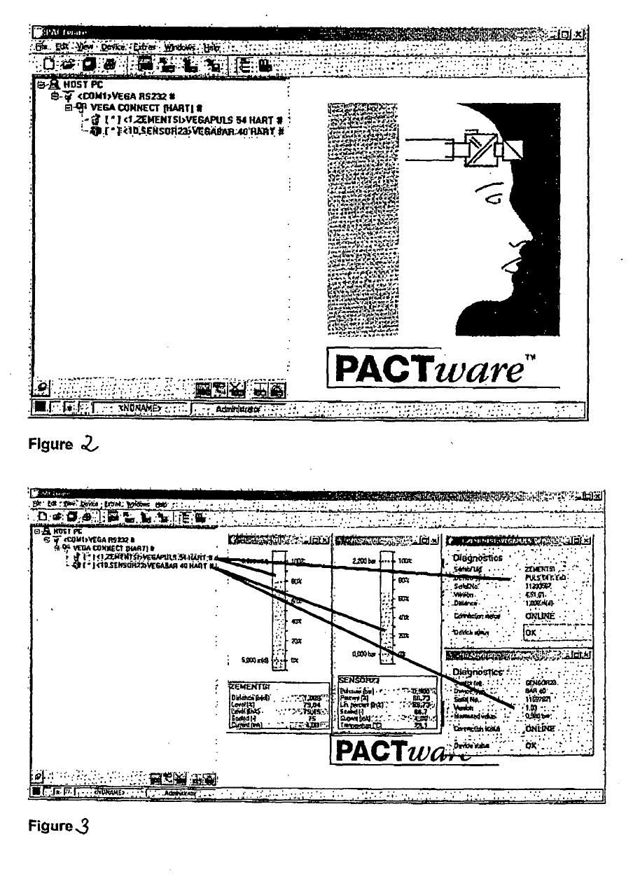

FIG. 2 displays a screenshot of a window of the PACTware software, indicating the tree structure of the process control system: A host PC having a serial interface is connected via a communication apparatus to two sensors. According to FIG. 3, the screenshot shows that there are different windows for visualizing measured values and diagnosis messages. Moreover, there are windows to change parameters of the respective elements. Theses windows can all be positioned freely on the working surface.

The present invention can be employed in operation tools as PACTware. These operation tools make different elements available in an apparatus catalogue for modeling a project. Single entities of these elements of the apparatus catalogue are then adapted into the project tree, to obtain a model of a real project from the sector process or automation, respectively.

Each of these elements in a project tree can make different windows for setting and monitoring a target apparatus available. Usually, the following groups are distinguished: display of measured values, diagnosis and parametrizing.

The handling software gains knowledge of all present properties of the elements involved and then stores these for restoring. These properties comprise in particular:
the list of all opened input windows as well as their position,
the communication status (online or offline) of each project node, as well as
the state of the respective operating interface of the respective input window.

For example, each input window can make several input forms available, on which several elements for data input are present. For the complete restoring of the state it is thus necessary, to transmit the current status of the user interface of the input window to the handling software. This can for example result such that according to the conventional interface method this current state of all opened windows is transmitted in respective XML strings to the handling software. Moreover, the handling software can influence the current state of the input window such that by using the conventional interface method, an XML string is transmitted to the window, describing the targeted state.

According to the present invention, the handling software is extended by the option to query the properties of all opened input windows of the project elements, and to store them subsequently. Moreover, the handling software is able to regenerate all current windows of a session and to relegate them into their original state. This mechanism operates for example by means of conventional interface methods, using XML strings as transmission parameter.

When leaving the user interface, the latter collects all information of the current view as well as the connection status (termed as session in the following). This information determined is stored in a non-volatile project directory (in the project file itself or in a separate file, being referenced in the project file).

When opening a project under the named operating interface, at first all project data is loaded. In a further step, the application verifies, whether the project file contains session information or a reference to a file containing session information, respectively. In case session information is present, then the last present sight of the project with all opened dialogs is regenerated on one hand, on the other hand, all connections, which were present during the last session, are regenerated. This mechanism can be integrated into the handling software permanently or can be provided as an add-in of the true handling software.

The handling software can also comprise a session manager. As can be seen from FIG. 4, the actual session can be stored according to this window. Also several sessions with respect to a project can be stored and the data restored. The information of a session comprises the list of all opened input windows with respective states. Thus, the data of the entire project is only existent for one time and is only stored at one point.

However, different views of the project can be defined. Thus, for example only distinct sections of the project can be combined to one view or several views with different tasks are defined. Hereby, a special view of the current diagnosis information or view for monitoring the current measurement values would be appropriate.

The session manager is able to manage a list of sessions with respect to each project as well as the names of the active session. In FIG. 4, a dialog is offered for storing of the session. In this dialog, a name for the session to be stored can be selected. In case the button provided in the dialog for storing the session is activated, then the session manager collects all information of the current view as well as the connection statuses. This information is added to the list of all sessions of the current project under the name selected for the session. In case the selected name already exists in this list, then information of the already present session is replaced by information of the current session. Further, the selected name is adopted as name of the active session. The updated list of the sessions as well as the name of the active session then is stored in a non-volatile project directory (in the project file itself or in a separate file, being referenced in the project file).

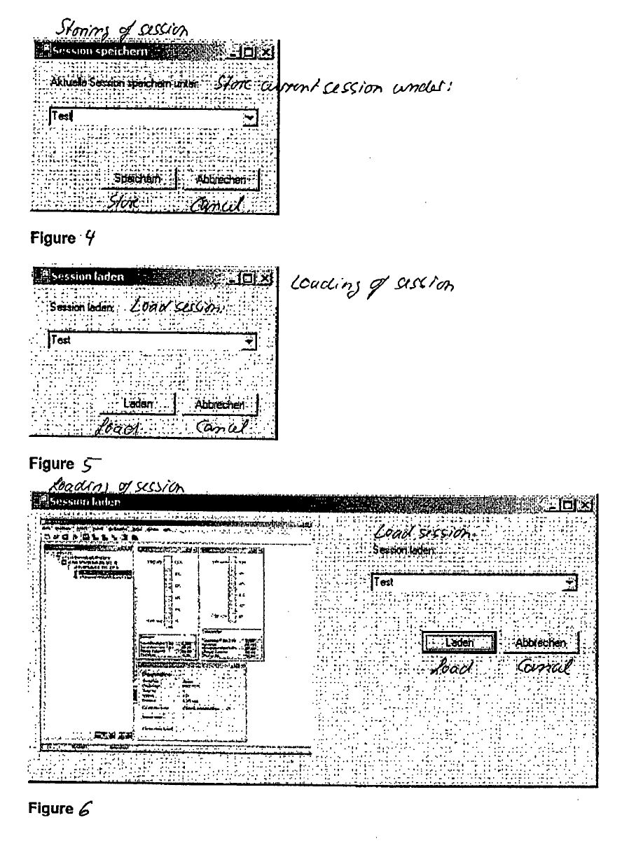

In FIG. 5, it can be seen that the session manager offers a dialog for loading a session. In the dialog, the names of all sessions being available for the project are offered for selection. As extension, the dialog can also offer a window, in which the session is displayed as preview, to facilitate the selection of the session to be loaded, as can be seen from FIG. 6 In case the button for loading of a session present in the dialog is actuated, at first all opened windows are closed. Then, the view of the project stored in the selected session with all opened dialogs is restored. Connections no longer required for the view to be loaded, are abolished. However, connections which are required, but are not present, are established.

The name of the session loaded is stored as active session in the non-volatile project directory (in the project file itself or in a separate file, being referenced in the project file).

Upon opening a project by means of the user interface, at first all project data is loaded. In a further step, the application verifies whether the project file contains session information or a reference to a file containing session information, respectively. In case session information is present, then it is verified whether a name of an active session was stored with respect to the project. Is this the case, the session stored under this name is regenerated. This procedure is the same as during loading of a session. As already mentioned, the session manager can either be a fixed component of the handling software or can be realized as add-in to the actual handling software.

The present invention can be employed to restore communication links present at the point of time of storing during loading of a project automatically. Therefore, the starting procedure of a project is rendered much easier. As in prior art it was necessary that every window had to be opened after loading of the project manually and the communication links had to be generated manually, on the basis of the present invention the manual activity can be automated. Also distinct communication links concerning distinct nodes of the whole project can be generated selectively. This is of particular importance with respect to shared systems, in which certain parts of the project are only accessible via modem connections. Here, according to the present invention, a precise definition, for which node a connection should be generated, and for which node no connection should be generated, is enabled.

1. A method for automatic modeling a process control system, whereby elements of a user interface are arranged in a tree structure reflecting the topography of the elements in the process control system, whereby each element is assigned to at least one input window having a plurality of attributes for setting and/or monitoring a target apparatus controllable in the process control system, whereby the current arrangement of the tree structure is stored as a project, and a list of all windows opened during the same current operation as well as their attributes are stored as an operating session, to thereby be able to restore the state of the elements when loading the process control system again.

2. The method according to claim 1, whereby a handling software is used to store the tree structure as well as the list of windows and their attributes, whereby the handling software further stores the position of the input windows during the current operation.

3. The method according to claim 2, whereby the handling software stores the communication status, indicating an online or offline status, respectively, for storing the state of the elements.

4. The method according to claim 2, whereby the handling software for storing the state of the elements stores the state of the associated user interface of the respective input windows.

5. The method according to claim 1, whereby only distinct communication links to distinct nodes of the complete project are selected to be restored.

6. The method according to claim 1, whereby the input windows for setting and monitoring the target apparatus provided by the elements in the project tree serve for display of measured values, for diagnosis or for parametrizing.

7. The method according to claim 1, whereby the current state of the input windows opened during operation of the process control system is transmitted to the handling software in a XML string.

8. The method according to claim 1, whereby the state of the input windows opened during operation of the process control system is queried and stored by conventional interface methods.

9. The method according to claim 1, whereby the projects and the associated states of the elements of the project are stored in project files.

10. The method according to claim 1, whereby session information is stored in the project files or references to the files including session information are stored.

11. The method according to claim 1, whereby upon opening the project it is verified whether session information is present, and if present, the last present view of the project with all opened dialogs is restored and all connections of the last session are restored.

12. The method according to claim 1, whereby a session manager manages a list of sessions and the names of the active sessions for each project and stores the latter in a non-volatile project directory.

13. The method according to claim 12, whereby the session manager offers a dialog during loading of a project, in which the names of all available sessions for a project are offered for selection.

14. A method for automatic modeling a process control system comprising at least one target apparatus, whereby elements of a user interface are arranged in a tree structure reflecting the topography of the elements in the process control system, whereby each element is assigned to at least one input window having a plurality of attributes for setting and/or monitoring the target apparatus controllable in the process control system, whereby a handling software stores the current arrangement of the tree structure as a project, a list of all windows opened during the same current operation as well as their attributes as an operating session, and the position and/or the communication status, indicating an online or offline status, respectively, of the user interface of a respective input window, to thereby be able to restore the state of the elements when loading the process control system again.

15. A process control system comprising a host PC and at least one target apparatus connected to the host PC via a bus system, whereby the process control system is adapted to be displayed in form of a tree structure on an input window, whereby the tree structure comprises nodes, each node providing at least one input window having a plurality of attributes for setting and/or monitoring a target apparatus assigned thereto, whereby a memory of the process control system is adapted to store the arrangement of the tree structure as a project, and a list of all windows opened during operation as well as their attributes as an operating session being automatically restorable during reloading of the process control system.

16. The process control system according to claim 15, whereby the memory is adapted to store the position of the input windows.

17. The process control system according to claim 15, whereby the memory is adapted to store the communication status, indicating an online or offline status, respectively, of the input window.

18. The process control system according to claim 15, whereby the memory is adapted to store the state of the user interface associated to respective input windows.

19. The process control system according to claim 15, whereby the memory is adapted to store several operating sessions for each project.

20. The process control system according to claim 15, whereby the system is adapted to be implementable permanently in a frame application.

21. The process control system according to claim 15, whereby the system is adapted to be implementable into the frame application as add-in.

22. The process control system according to claim 15, whereby the input windows are windows for visualizing measurement values obtained by the at least one target apparatus.

23. The process control system according to claim 15, whereby the input windows are windows for diagnosis messages.

24. The process control system according to claim 15, comprising a session manager.
